(19) United States
(12) Patent Application Publication
(10) Pub. No.: US 2006/0294187 A1
(43) Pub. Date: Dec. 28, 2006

(54) Integrated web communications system

(76) Inventors: Thomas Hakel, Santa Rosa, CA (US); David Simpson, San Francisco, CA (US)

Correspondence Address: DLA PIPER RUDNICK GRAY CARY US LLP, 153 TOWNSEND STREET, SUITE 800, SAN FRANCISCO, CA, 94107-1907, US

(21) Appl. No.: 11/039,647

(22) Filed: Jan. 19, 2005

Related U.S. Application Data
(60) Provisional application No. 60/537,512, filed on Jan. 20, 2004.
(60) Provisional application No. 60/539,477, filed on Jan. 26, 2004.

(51) Int. Cl. G06F 15/16

(52) U.S. Cl. 709/206

(57) ABSTRACT

A system for creating audio/visual content from within an email application includes a personal communications web page, an integrated web communications menu, an email communication component and a web browser. The web communications menu includes a URL corresponding to the web page and an encrypted identification and password. The email communication component enables the creation of audio/visual content, the uploading of the content, and the sending of secure content links within the web page. The web browser launches the web page at a selected email communication function within the web page.

### PRIORITY

This application claims the benefit of priority to U.S. provisional patent application Ser. Nos. 60/537,512, filed Jan. 20, 2004 and 60/539,477, filed Jan. 26, 2004.

### BACKGROUND

1. Field of the Invention

The invention relates to web communications, and particularly to an email application that permits real-time creation and communication of audio/visual content.

2. Description of the Related Art

There is a need in this field to have an integrated web communications system includes the comprehensive capability to create audio/visual email content using a voice communications network and an Internet browser and the additional capability to distribute and manage the content from any existing email or contact management application including but not limited to Outlook™, Outlook Express™, Lotus Notes™, Yahoo! ™ or MSN™ (collectively the email and contact management applications are referred to as “Email Applications”). Therefore, a system in accordance with the invention and/or a preferred embodiment of the invention provides the ability to do the following:

First, it provides the ability to create audio streams directly from the Email Applications using the public switching telephone network (PSTN) or voice over Internet protocol (VoIP) and synchronize those voice audio streams with any documents, videos, web URLs or other content (collectively referred to as “Content”). The voice audio stream recording with the synchronized Content is referred to hereinafter as “audio/visual content”. Second, it provides the ability to distribute links to said audio/visual content directly from the Email Applications. Third, it provides the ability to present all audio/visual content in a secure personal communications webpage. Fourth, it provides the ability to secure access to said audio/visual content solely to users on the recipient email. Fifth, it provides the ability to perform reporting and tracking of any or all access and viewing of said audio/visual list content directly from the Email Applications.

### BRIEF DESCRIPTION OF THE DRAWINGS

FIG. 1 is an exemplary screenshot that illustrates an integrated web communications menu in accordance with a preferred embodiment including an embedded button for expanding a basic email application system.

FIG. 2 is an exemplary screenshot that illustrates a personal web communications web page in accordance with a preferred embodiment.

FIG. 3 is an exemplary screenshot of an email wherein audio/visual content viewing is initiated by clicking a link embedded within the email.

FIG. 4 illustrates an audio/visual content viewing and email applications integration component architecture in accordance with a preferred embodiment.

FIG. 5 is an exemplary screenshot that illustrates email reporting and tracking of recipient viewing activity in accordance with a preferred embodiment.

FIG. 6 illustrates an integrated web communications API architecture in accordance with a preferred embodiment.

FIG. 7 illustrates a platform application component structure in accordance with a preferred embodiment.

### DETAILED DESCRIPTION OF THE PREFERRED EMBODIMENTS

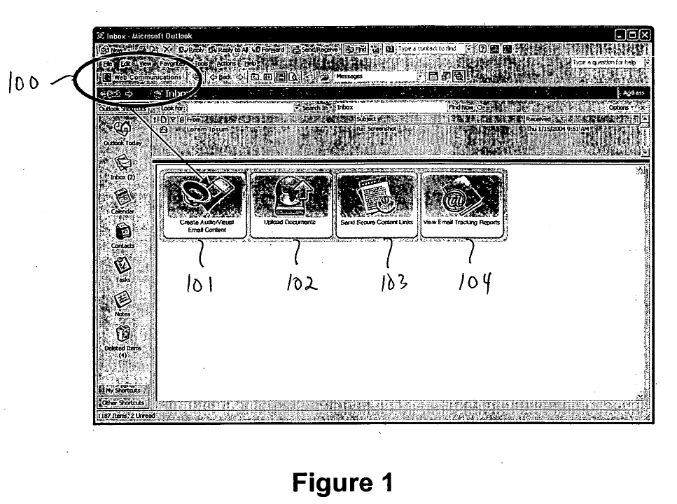

Features and components of preferred embodiments of the invention are described below with reference to FIGS. 1-7.

### Integrated Web Communications Menu

Referring to FIG. 1, from an email applications, a user can click a “communications icon” 100 and receives a menu of choices that allow for the creation, distribution, viewing and tracking of communications including audio/visual content. This integrated web communications menu is accessible via the communications icon 100 as an embedded button or tool in the email application. This allows a user to expand the functionality of a basic email application system, e.g., Microsoft Outlook™. The communications icon 100 is installed by the registered user of the email application. When the user clicks the icon 100, a graphics sub-menu of expanded functionality allows the user to choose from four core communications functions represented by icons 101-104.

The four icons 101-104 that are shown in FIG. 1 appear when the web communications icon 100 is clicked. By clicking the icon 101, a user will move to a window for creating audio/visual email content. Clicking icon 101 provides a user the ability to record audio and visual content that may be later communicated by email. The icon 101 is a window that appears within the email application and provides a user with access to a real-time recording studio capability. The user may synchronize voice content (PSTN or VOIP, e.g.) with other content.

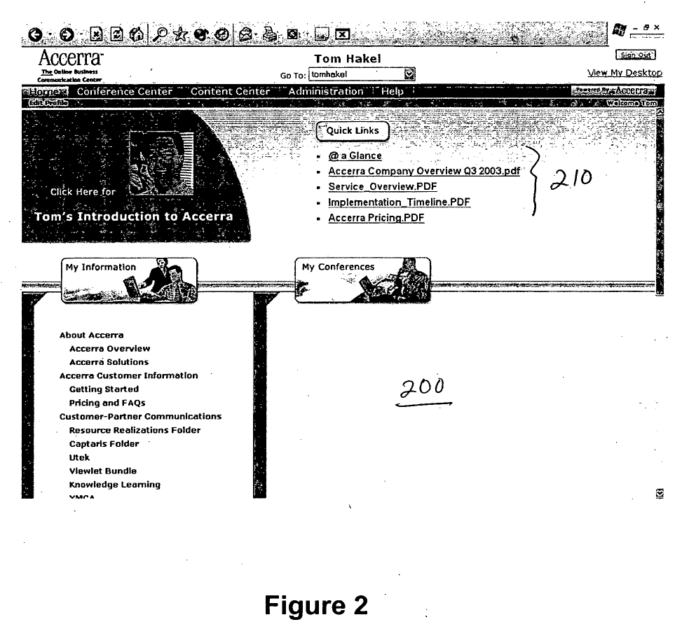

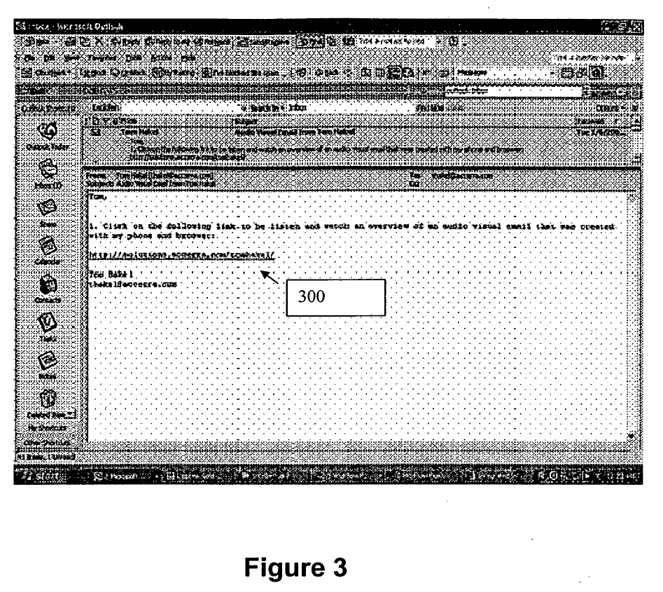

By clicking the icon 102, a user will move to a window that appears within the email application providing the user the ability to upload electronic content from the user's desktop or network onto a personal communications web page (see FIG. 2). By clicking the icon 103, a user may send a secure content link (see FIG. 3). By clicking the icon 104, a user may view email tracking reports (see FIG. 5).

This system provides an advantageous communications service that allows an email user the ability to create real time audio/visual Content from within an email application via an integrated web communications menu (FIG. 1) and associated web page (FIG. 2). The integrated web communications menu icon 100 within the email application contains an email user's associated web URL and an encrypted identification and password. This information, along with the email communication function desired (i.e., create audio/visual content 101, upload content 102, send secure content links 103, and view email reports 104), is launched through an internet browser and brings the email user directly to the specific function within the personal communications web page 200 (see FIG. 2). This provides an integrated communication function that expands the capability of traditional email.

The system further provides the ability to add real-time voice overlays to any content or series of content directly from an integrated service launched from within the email application. Upon completion of the voice overlay, the user has created audio/visual content and is returned directly back to the email application.

### Personal Communications Web Page

A personal communications web page is illustrated at FIG. 2. A personal communications web page is a folder or actual web page. FIG. 2 illustrates a web page template. The web page has a specific IP address that is directly and uniquely associated with communications icon 100. This web page allows users to upload, save, share and organize electronic content directly using their email application addresses. The screenshot of FIG. 2 includes a set of “Quick Links” 210, which includes links to various electronic content.

Each email application user is assigned his/her own integrated personal communications web page. From this web page, which can be customized by the user, any documents, audio/visual content, videos, web URLs or other electronic content is presented and shared in a secure and restricted manner with a viewer or email recipient.

This advantageous integration provides a communications service that provides email application users with an integrated Internet-based, web communications page for managing, presenting and organizing Content. Users of email applications can now deploy true content management from within their existing email application.

### Communication of Secure Links

Referring to FIG. 3, a secure email link 300 is illustrated. When a user selects to send an audio/visual or other electronic content from their personal communications web page (see FIG. 2), an encrypted link 300 to the content is automatically generated and pasted into the body of the email. Thus advantageously, the content may be then sent to an email recipient as a secure, encrypted link. There do not need to be any documents or attachments. This provides the sender with document control, management and security.

This communications service allows the email user the ability to both access and send secure links to content from within an email application via an integrated web communications menu and associated communications web page. The user remains in control of the content at all times (versus the traditional email method of sending an attachment). This allows the user to delete, modify or restrict access to content even after sending out the email link to the information.

Automatic content management and control are thus further advantages of the system of the preferred embodiment. This communications service creates an automatic restriction on content without requiring the user to set up- groups or content management lists. Each piece of content on the personal communications web page has an associated and unique “access list”. Only recipients belonging to a specific access list can view or download the associated content. As a default, the system automatically adds email recipients (individuals or groups) that received a link to a piece of content to the access list for that content. Users can also manually add individuals or groups from within their email application directly to a specific access list without sending an email link. The user can thereby manage and control content without having to learn how to utilize a content management system that requires extensive knowledge and effort. The automatic content system of the preferred embodiment is an advantageous email application that provides this capability of content control to the user.

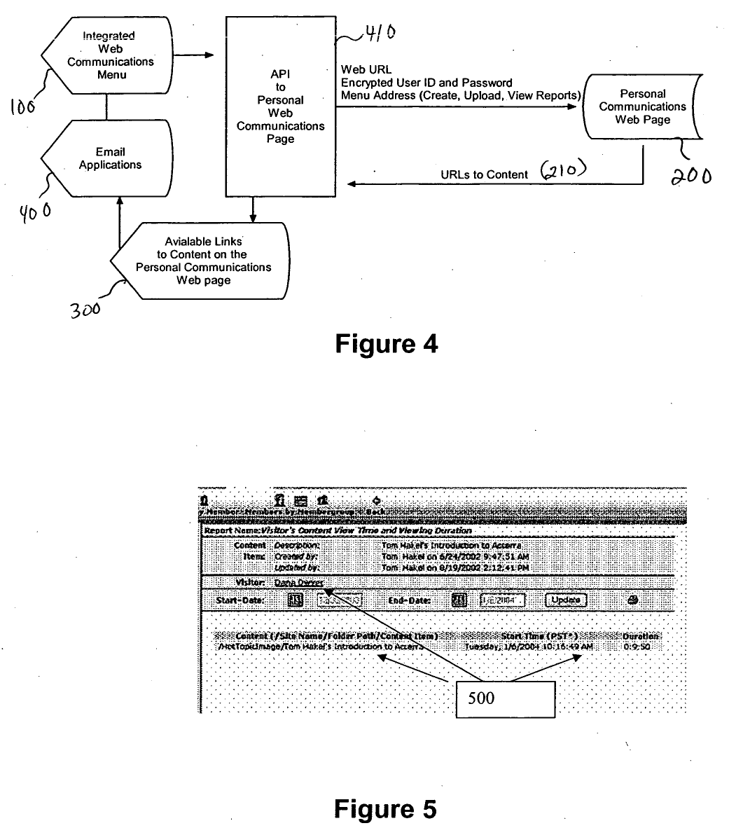

FIG. 4 is a graphic that illustrates the integration of web-based content creation with content delivery. The integrated web communications menu of FIG. 1 is represented by block 100. Email applications running on a user's computer include the icon of FIG. 1 that provides the four menu items 101-104 in accordance with a preferred embodiment. This menu 100 communicates with an API 410 that takes a user who clicks one of the icons 101-104 to a web page 200. URLs to content 210 are generated and communicated. Preferably, all electronic content and audio/visual recording from the personal communications web page 200 have a unique URL 210 associated with that content. One or more available links 300 to content on the personal communications web page are provided that may be accessed within emails available using an email application. The links 300 are windows that appear within an email application providing the user with a list of the content available on the personal communications web page 200. Each piece of content, and the underlying URLs to content, can be encrypted and added to the body of an email from within the email application.

### Email Reporting and Tracking of Recipient Viewing Activity

Referring to FIG. 5, upon clicking icon 104 from the menu 100 of FIG. 1, a reporting and tracking window opens. The reporting and tracking window 500 includes information such as the visitor to the web page 200, the time, and the content that was accessed. That is, from an email application, a user can produce a report of activity relating to recipient viewing, including details time spent on actual content (who, when and how long content was viewed). The reports are displayed online for the email user by clicking on the view email reports icon 104 within the email application menu 100. This reporting tool is dynamic and allows a user to track all receipt and viewing of email content. In fact, this communications service allows the email user the ability to view in a report format all activity associated with the viewing of multiple pieces of content from within an email application. User's have a “closed loop” on email communications using this system. They can now not only get information of who received their email, but they can actually validate the effectiveness of their communications by seeing when the actual content was opened, how long the content and related information was viewed and what other information may have been viewed from the personal communications web page 200 by the email recipient.

### Seamless Web Communication

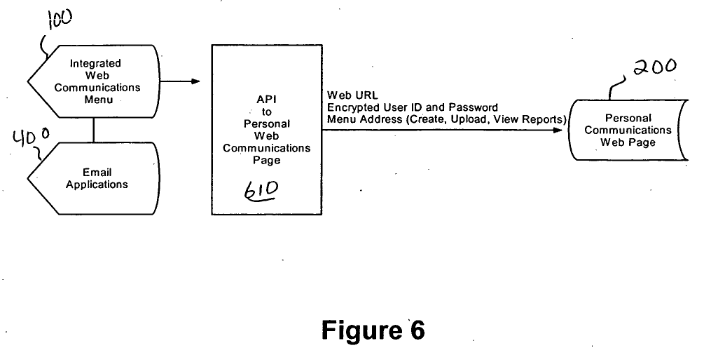

Referring now to FIG. 6, a feature of the design of an integrated web communications system (“IWCS”) in accordance with a preferred embodiment involves the ability to provide extended web communication services in a seamless fashion with any email application. To that end, the API 610 of FIG. 6 acts as a “hand shake” between the email application and the web communications service. The API 610 and related data for that specific user is embedded with the communications icon 100 after user installation. When the communications icon 100 is clicked from the email application and a function (e.g., 101-104, see FIG. 1) is chosen, the API 610 manages the interface between the email application and the tools and electronic content residing on the personal communications web page 200.

The process of seamless communication preferably involves the following. For a one time installation of the ICWS, a user would first preferably provide his/her name and email address. Once the user chooses a name for the ICWS site, then a URL (i.e., web address) for that communications page is established (hereinafter the “URL”). The email address of the user is used as the unique User ID. A password is established by the user (collectively the User ID and password are the “ID”). The ICWS icon is installed on the user's email application and desktop. The icon contains a file that includes the URL and ID.

When a user selects one of the four communications services 101-104 from the ICWS icon (see FIG. 1), the following actions preferably occur. First, a temporary file is created by clicking one of the icons 101-104. This file contains the ID and URL information and a numeric character 1 through 4 containing the selected action. The system then opens an internet browser and goes to the particular user's URL. The user ID is validated and the user is logged onto the ICWS communications page and taken to the toolbar for the particular action.

That toolbar preferably includes a recording studio, upload content and view email reports options. The recording studio offers a user the ability to record voice audio over content. The upload content option permits a user to post presentations or documents from their PC or network directly to their ICWS communications page. The view email reports option allows users to view, print and manipulate activity reports detailing all viewers of information on the ICWS communications page.

In the event the user selects “Send Secure Content Links” 104 from the menu 100, the same login process occurs. Once the ICWS communications page 200 is accessed, the appropriate file is retrieved (i.e. a file listing the name and encrypted links 210 for all available content on the ICWS communications page 200). That file is then presented to the email user via a window that can be viewed from within the email application. The user selects the appropriate content from the file window that is to be sent from the email application. The content link 300 (which contains the URL to the specific content on the ICWS communications page 200) is encrypted and made available in the text portion of the actual email.

On the backend of the system, an access list is preferably maintained for each element of content on the ICWS communications page 200. This access list contains a list of IDs for all viewers (i.e. email recipients) that are allowed to view or download the specific content. If the ID is not contained in the access list, the content cannot be viewed or downloaded. When a secure content link is sent from within the email application, the following preferably occurs. First, the email address of the email recipients for that specific content are written to a temporary “access” file along with the content link. At the option of the email user, the ICWS communications page 200 can be accessed automatically (i.e. after each email, at a set interval or manually) for update. At the time of update, the temporary “access” file is sent to the ICWS communications page 200 and the appropriate access list is updated. his process is referred to as automatic content management.

### About the Platform

Functional elements of the proposed platform for the recording studio and upload content options within the ICWS communications page are preferably built upon a platform in accordance with a preferred embodiment, such as that of Accerra Corporation. A platform in accordance with a preferred embodiment is designed for maximum scalability and reliability. It is a multi-tiered server architecture built with distributed, standards-based software architecture. This architecture provides a comprehensive set of functionality for web-based interactive content creation, management and communication services.

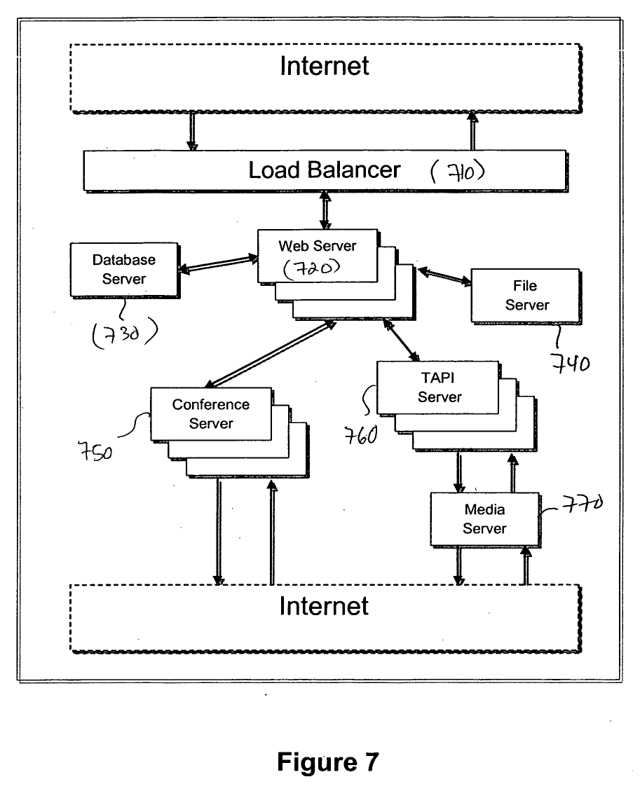

The components comprising a preferred platform architecture are illustrated at FIG. 7. A load balance environment 710 is an environment that distributes HTTP requests across the pool of available web servers 720 ensuring that these web servers 720 are approximately equally utilized. If a web server 720 goes out of service, load balancing 710 excludes that web server 720 as a candidate for work in its load distribution algorithm. The web servers 720 include multiple internet information servers 720 that are available for servicing HTTP requests. User's session variables are maintained in a database table by a 3^{rd} party component that replaces the standard internet information server session object with a global session object, accessible to all web servers 720.

A database server 730, preferably a Microsoft SQL server, is used for data requirements of the application. Data stored on the database server 730 includes user information, site information, content organization information, and session data. A file server 740, preferably a Microsoft Windows 2000 server, is used for storing user content. Content is stored in the form of file system files, and can only be accessed internally or via the platform application. Internal access is for maintenance and backup, while the application access provides platform users with a secure mechanism of maintaining and distributing their content files.

Conference servers 750 are preferably Windows 2000 servers. The platform (Accerra) conference servers 750 preferably run as a Windows NT Service. The conference server 750 is controlled by the platform application, and is used to communicate event control and content information to event attendees. The TAPI servers 760 are preferably Windows 2000 workstations on which the platform TAPI server 760 runs as a Windows NT service. Each server 760 also preferably runs Windows Media Encoder, and contains a Dialogic multi-line device for receiving calls from a recording host. Multiple encoding sessions are possible this way, as each input line also serves as a wave input device from which recorded audio is captured.

The platform also preferably utilizes a Windows media server 770. When clients playback a recorded event, they do so by connecting to the Windows media server 770, which contacts either the TAPI Server 760 (live broadcast events) or obtains the media file (recordings) to obtain the media stream. The server 770 streams the media to the client for playback Interprocess communications between web servers 720, conference servers 750 and TAPI servers 760 are preferably accomplished using Simple Object Access Protocol or SOAP.

SOAP is advantageous in several ways. Communication via SOAP is very efficient and quick. The underlying communication layer is implemented using Windows Sockets, which is an efficient communication mechanism. The platform (Accerra) SOAP implementation includes back-pressure and failure notification, eliminating the possibility of a hung system when a service provider either cannot complete a request in an acceptable time or fails while carrying out the request. SOAP is platform independent. This enables 3^{rd} party components not written on Windows platforms to be utilized without affecting the communications infrastructure already in place. Configuration of SOAP servers and clients is a much simpler process than the same with DCOM as the communications mechanism. As all servers communicate with each other within a protected environment, the stringent security rules implemented in DCOM are not necessary. This eliminates complicated implementation procedures, and potential communication failures after new implementations.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A web-based system for creating and communicating real-time audio/visual content from within an email application, comprising:
(a) a personal communications web page for creating and uploading audio/visual content;
(b) an integrated web communications menu integrated within an email application including a URL corresponding to said web page and an encrypted identification and password;
(c) an email communication component for sending a secure link to particular content within the web page; and
(d) a web browser for launching the web page to display the particular content that corresponds to the secure link, and
(e) wherein the menu comprises content creating and uploading components that launch the web page upon execution, and a secure link sending component that maps the web page content into the email communication component, so that the web page content is communicated from within the email application.

2. The system of claim 1, the communication component further for managing, presenting and organizing the content.

3. The system of claim 1, the system being configured for permitting both access to the content links and ability to electronically send the links.

4. The system of claim 1, wherein the content comprises an access list such that only recipients belonging to the access list are able to view and/or download the associated Content.

5. The system of claim 4, the system being configured such that by default a recipient of an email containing the content is automatically added to the access list.

6. The system of claim 1, the communication component further for viewing email reports.

7. The system of claim 6, wherein the email reports comprise activities associated with the viewing of the content.
